(19) United States
(12) Patent Application Publication
(10) Pub. No.: US 2003/0066234 A1
(43) Pub. Date: Apr. 10, 2003

(54) Potting system for plants, shrubs and trees

(76) Inventor: Harry Bussey JR., Marco Island, FL (US)

Correspondence Address: Francis C. Hand, Esq., c/o Carella, Byrne, Bain, Gilfillan, Cecchi, Stewart & Olstein, 6 Becker Farm Road, Roseland, NJ, 07068, US

(21) Appl. No.: 09/971,728

(22) Filed: Oct. 5, 2001

(51) Int. Cl. A01G 9/02

(52) U.S. Cl. 47/65.7

(57) ABSTRACT

The potting system employs a flower pot, a layer of discrete loose fill polymeric material in the bottom of the pot and a layer of potting soil over the layer of polymeric material. Over time, the roots of a plant potted in the potting soil grow into the layer of polymeric material. The polymeric material is water adsorbent to retain water thereon and is composed of randomly spaced elements to form air spaces for retaining air. The combination of the water retention and aeration are believed to enhance the growth of the plant. The polymeric material may be packaged in mesh packets for ease of use.

This invention relates to a potting system for plants, shrubs and trees and to a packet for enhancing plant growth.

Heretofore, various types of potting techniques have been known for growing plants, such as flowers, vegetables, shrubs and trees. Typically, the plant has been placed in soil either in a pot or in the ground along with a fertilizer or other growth enhancing materials, such as a water absorbing material, e.g. vermiculite.

It is an object of the invention to enhance the growth of plants with entrapped water and air.

It is another object of the invention to provide a packet of material for enhancing the growth of plants.

Briefly, the invention is directed to a potting system for plants, shrubs and trees. The potting system is comprised of a container, a layer of discrete growth enhancing elements in the container and a layer of potting soil over the layer of elements for growing of a plant therein.

Typically, the container has a bottom, a peripheral wall extending upwardly from the bottom, and a plurality of drainage holes in at least one of the bottom and the wall.

Preferably, the discrete growth enhancing elements are made of loose fill polymeric material. However, the elements may also be made of wood chips, shredded tree bark, and pieces of ground rubber tires and the like. The discrete elements are characterized in being water adsorbable to retain water and as being randomly disposed to define air spaces for retaining air. The term “adsorbable” means that the nature of a growth enhancing element is such that water clings to the surface of the element.

In addition, the invention provides individual packets formed of a closed container with holes, for example, a closed mesh bag, and a mass of the discrete elements. The holes in the container are sized to permit water to flow into and through the bag, to retain the contents of the bag in place and to permit the roots of plants to grow therethrough.

The packets may be suitably sized for a container which is to receive a plant, shrub, tree or the like. Also, the packets may be supplied in roll form, for example, as a 6 inch by 20 foot roll for field planting.

Typically, a layer of the discrete elements is initially filled into an empty container and then covered over with potting soil. A plant, shrub or tree is then potted into the soil.

In one embodiment, the discrete elements may be loosely poured into the container. In other embodiments, one or more packets of the discrete elements sized to the container may be deposited in a container for ease of placement.

In cases where the discrete elements are used in large planting areas, holes are first dug in the planting area. A layer of the discrete elements or a packet thereof is then placed in the bottom of each hole and then covered over with soil at or prior to planting of the plant, shrub or tree.

In accordance with the invention, the discrete elements may be provided with fertilizer. For example, the fertilizer may be sprayed onto the growth enhancing elements at the time of manufacture of the elements or the time of implantation. Likewise, an insecticide may be provided on the elements. In either case, the fertilizer and/or insecticide may be of a time-release type so as to release nutrient or insecticide over a period of time for the growing plant, tree or shrub. Further, the elements or the packet may be color-coded depending upon the intended use. For example, the elements or packet may be green colored for growing flowers, brown coated for growing vegetables, and the like. Color coating may also be used to indicate whether or not the elements have been precoated or pre-impregnated with a fertilizer and/or insecticide.

In one embodiment, the elements are made of expanded polystyrene loose fill wherein the loose fill is comprised of discrete elements of C-shape, S-shape, E-shape and the like. Spherical particles and shredded expanded polystyrene (EPS) are also suitable.

In accordance with the invention, a small mass of loose fill material composed of polystyrene was placed in a flower pot to a depth of four inches. Thereafter, a layer of soil was placed over the loose fill material and a small shrub was placed in the soil. The pot had a height of 12 inches and was provided with small holes at the bottom for drainage purposes. The holes were made smaller than the foamed polymeric material.

Over a period of time, employing normal water cycles, it was found that the shrub grew more rapidly and lusher than if the shrub had been planted in only soil. In this respect, it is believed that the loose fill material adsorbed the water used in watering the flower pot, i.e. allowed the water used to cling therero, so that the water did not completely drain out of the soil and flower pot as would be the case without the use of the loose fill material. In addition, the loose fill material provided an environment which was aerated due to the spaces between the discrete pieces of the randomly placed loose fill material. The combination of the retained water and the aeration appears to have been responsible for the faster and lusher growth of the potted plant. Further, the loose fill material serves to insulate the plant roots.

After a period of time, the plant was removed to inspect the root system. It was found that the root system grew not only within the soil but also into and through the loose fill material.

These and other objects and advantages of the invention will become more apparent from the following detailed description taken in conjunction with the accompanying drawings wherein:

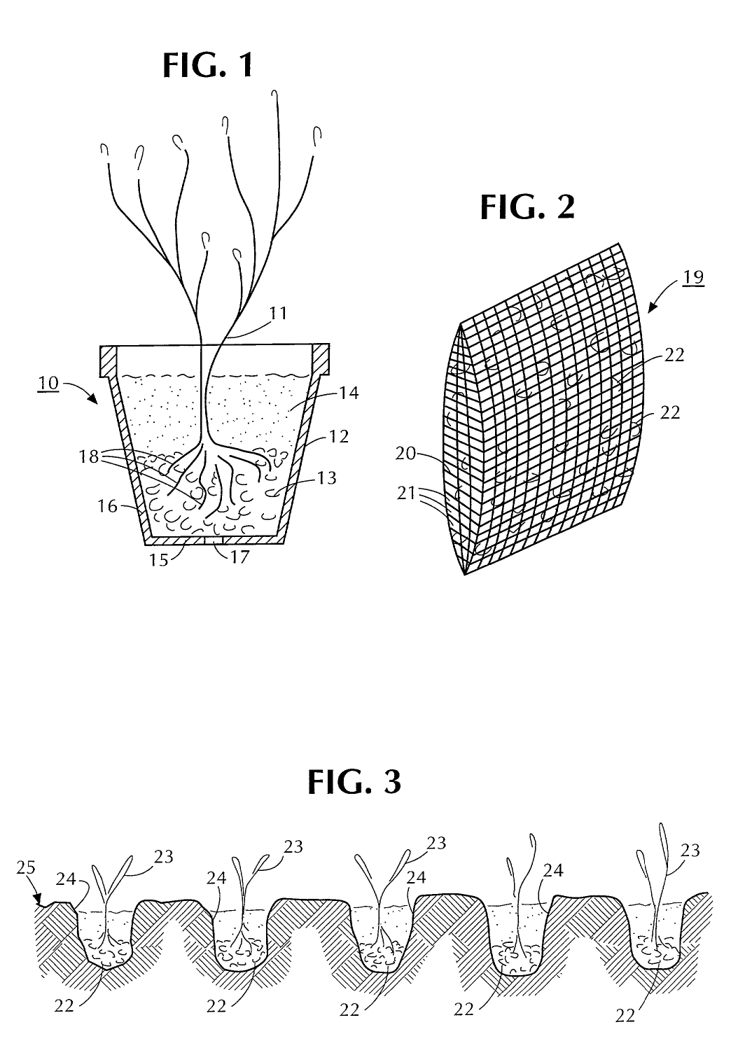

FIG. 1 illustrates a cross sectional view of a flower pot containing a layer of loose fill material and a layer of soil for receiving a plant in accordance with the invention;

FIG. 2 illustrates a netted bag containing a mass of loose fill material in accordance with the invention; and

FIG. 3 schematically illustrates a cross sectional view of a field of plants potted in accordance with the invention.

The term “plant” is intended herein to cover flowers, vegetables, bulbs, shrubs and trees and the like.

Referring to FIG. 1, the potting system 10 for a plant 11 includes a container 12, a layer 13 of discrete elements and a layer 14 of potting soil over the layer of discrete elements.

As illustrated, the container 12 is of conventional flower pot construction having a flat bottom 15 and a peripheral conical wall 16 that extends upwardly from the bottom 15. In addition, the container has one or more drainage holes 17 formed in the bottom 15 and the wall 16 (not shown).

The discrete elements in the layer 13 are of a size greater than the size of the hole 17 in the container 12 in order to be retained therein. In addition, the elements of the layer 13 are characterized as being made of water adsorbable material for retaining water within the layer 13 while also being randomly disposed to define air spaces therebetween for retaining air within the layer 13. Typically, the discrete elements are made of loose fill foamed polymeric material, for example, loose fill material sold under the name CUSHION PAK by CPI Packaging, Inc. of New Jersey. In this case, the elements may have random shapes such as a C-shape, L-shape, E-shape and the like.

The layer 14 of potting soil is of any conventional type of potting soil.

After potting of a plant 11 in the potting system 10, for example by being placed within the layer 14 of potting soil, and being watered, the plant 11 eventually grows with the roots 18 thereof infiltrating into the layer 13 of discrete elements.

It has been found that the use of a loose fill polymeric material for the elements of the layer 13 enhance the growth of the roots 18. In this respect, water is adsorbed (clings) onto the elements of the layer 13 rather than draining through the opening 17 in the container 12. Also, the water is prevented from flooding the pot and pooling up in the bottom of the pot. This avoids the plant roots from having “wet feet” or rot. In addition, air which is trapped within the layer 13 serves to aerate the roots 18. Accordingly, the combination of retained water and trapped air and the insulating characteristics of the material enhances the growth of the roots 18 and thus of the plant 11.

The potting system 10 may be marketed with a plant 11 already potted in place as a ready-to-grow product.

Alternatively, a user may be separately supplied with the components of the potting system so that the user fills the pot 12 with the layer 13 of discrete elements to a desired height and thereafter complete filling of the pot with the layer 14 of potting soil. At the same time, the user would place the plant 11 in the layer 14 of potting soil.

In the event that a plant is to be re-potted or moved to a larger potting site, the plant 11 may be removed from the pot 12. In accordance with the invention, the roots 18 of a plant 11 would be entangled with the elements of the layer 13. The discrete elements may then be brushed off from the roots 18, for example, for disposal purposes. Otherwise, the elements may be left on the roots 18 and the plant repotted in a larger pot, in the ground or elsewhere. A fresh supply of discrete elements may also be charged into the re-potted site.

Referring to FIG. 2, a self contained packet 19 may be supplied to a user for enhancing plant growth. As illustrated, the packet is comprised of a closed container 20. For example, a mesh bag having a plurality of holes 21 therein that are sized to permit drainage of water therethrough and to permit plant roots to grow therethrough. In addition, the packet 19 has a mass of discrete elements 22 within the mesh bag 20 that are of a size greater than the size of the holes 21 in the bag 20 in order to be retained therein. These elements 21 are made of water-absorbable material for retaining water and are randomly disposed to define air spaces therebetween for retaining air.

The packet 19 provides a predetermined mass of discrete elements 21 to facilitate use by a user. For example, instead of pouring a mass of elements into a flower pot, a packet 19 may be placed on the bottom of the flower pot and then covered over with a layer of potting soil as above.

Depending upon the size of the container into which a plant may be placed, one or more packets may be employed. For example, for a small plant, one packet may be sufficient. For a shrub, a small tree, a plurality of packets may be placed in a container and then covered over with potting soil or one larger packet may be used.

The packet 19 may be suitably sized for the container into which the packet is to be placed. For example, the packet 19 may be sized to be placed into a one gallon pot, a five gallon pot or the like.

The used of packets 19 provide several advantages. First, the packet 19 allows the loose fill material to be easily handled and contains the material while planting. Second, the packet 19 prevents the loose fill material from being blown around. Third, the packet allows the loose fill material to be easily disposed of after its useful life has expired.

Referring to FIG. 3, a field of plants 23 may be potted in accordance with the invention. In this respect, a number of holes 24 are formed in a ground surface 25, for example, in a row or grid, particularly for growing vegetables. Thereafter, a mass of discrete elements 22 are poured into each hole 24 or a packet 19 (not shown) may be placed in each hole 24. Thereafter, a layer of potting soil 25 is placed in each hole along with the plant 23. Alternatively, a field may be planted using a roll of spaced apart packets of loose fill material. In this case, a trench may be formed in which the roll of packets may be lain with a layer of soil placed thereon. Also, a roll of loose fill material could be placed in a growing environment with a layer of soil on top.

In accordance with the invention, the discrete elements of the various embodiments may be provided with a time release fertilizer for fertilizing a plant and/or insecticide for controlling pests on a plant. In either case, the discrete elements may be coated or otherwise impregnated with the fertilizer and/or insecticide at the time of manufacture or shortly thereafter.

In accordance with the invention, the individual discrete elements 22 and/or the bag 20 (see FIG. 2) may be color-coated to indicate the type of plant for which the discrete elements are intended to be planted. For example, the elements or packet may be green colored for growing flowers, brown coated for growing vegetables and the like. Color coating may also be used to indicate that the elements have been pre-coated or pre-impregnated with a fertilizer and/or insecticide.

While loose fill polymeric material has been found to enhance the growth of plants, it is believed that similar discrete elements having similar properties would serve the same purpose. For example, it is believed that wood chips, pieces of ground rubber tires, and pieces of shredded tree bark would be suitable. Further, whereas loose fill polymeric material typically has a smooth “skin” that is impervious to the passage of water, elements of this loose fill material may be fractured to provide a greater surface for water, fertilizer, and/or insecticide to cling to. The fracturing of the loose fill material, for example, by placing cuts in the skin, allows the interior cell structure of the material to be available to the water, fertilizer, and/or insecticide thereby allowing more of the water, fertilizer, and/or insecticide to be retained. Some of the fractured cells of the loose fill material will also take on a small amount of water, fertilizer, and/or insecticide. Also, the elements may made of a foam that will not crush and not allow air to pass through, i.e. low density polyurethane foam.

The growth enhancing elements may be provided in different shapes to provide greater surface areas for the water, fertilizer, and/or insecticide to cling to and to permit the passage of air.

The growth enhancing elements may be provided in blends of different materials. For example, the elements include a blend of pieces of sponge for absorbing water and pieces of loose fill material polymeric material for the passage of air and root growth.

The invention thus provides a potting system of relatively inexpensive materials which can be employed to enhance the growth of plants.

The invention further provides packets of growth enhancing elements which can be readily handled by a user.

What is claimed is:

1. A potting system for plants comprising
a container having a bottom, a peripheral wall extending upwardly from said bottom, and a plurality of drainage holes in at least one of said bottom and said wall;
a first layer of discrete growth enhancing elements on said bottom; and
a second layer of potting soil over said first layer for growing of a plant therein.

2. A potting system as set forth in claim 1 wherein said elements of said first layer includes a time release fertilizer for fertilizing a plant in said second layer.

3. A potting system as set forth in claim 2 wherein said elements of said first layer includes an insecticide for controlling pests on a plant in said second layer.

4. A potting system as set forth in claim 1 wherein said elements of said first layer is color-coded to indicate the type of plant to be planted in said second layer.

5. A potting system as set forth in claim 1 wherein said elements of said first layer is encased in a bag having a plurality of holes therein of a size smaller than said discrete elements and sufficient to allow drainage of water and passage of plant roots.

6. A potting system as set forth in claim 5 wherein said bag is color-coded to indicate the type of plant to be planted in said second layer.

7. A potting system as set forth in claim 1 wherein said elements are a loose fill polymeric material.

8. A potting system as set forth in claim 7 wherein said elements have a smooth skin impervious to the passage of water.

9. A potting system as set forth in claim 8 wherein said elements have a fractured skin to expose the interior thereof to receive water.

10. A potting system as set forth in claim 1 wherein said elements are made of wood chips.

11. A potting system as set forth in claim 1 wherein said elements are made of pieces of ground rubber tires.

12. A packet for enhancing plant growth comprising
a closed container having a plurality of holes therein, said holes being sized to permit drainage of water therethrough and to permit plant roots to grow therethrough; and
a mass of discrete elements in said container, said elements being of a size greater than the size of said holes in said container to be retained therein, said elements being made of water-adsorbable material for retaining water within said mass and being randomly disposed to define air spaces therebetween for retaining air within said mass.

13. A packet as set forth in claim 12 wherein said elements include a time release fertilizer for fertilizing a plant.

14. A packet as set forth in claim 12 wherein said elements include an insecticide for controlling pests on a plant.

15. A packet as set forth in claim 12 wherein said elements are color-coded to indicate the type of plant

16. A packet as set forth in claim 12 wherein said elements are a loose fill polymeric material.

17. A packet as set forth in claim 16 wherein said elements have a smooth skin impervious to the passage of water.

18. A packet system as set forth in claim 17 wherein said elements have a fractured skin to expose the interior thereof to receive water.

19. A packet as set forth in claim 12 wherein said elements are made of wood chips.

20. A packet as set forth in claim 12 wherein said elements are made of pieces of ground rubber tires.

21. A packet as set forth in claim 12 wherein said container is a mesh bag.

22. A packet as set forth in claim 12 wherein said elements include a blend of pieces of sponge for absorbing water and pieces of loose fill material polymeric material for the passage of air and root growth.

23. A packet as set forth in claim 12 wherein said elements are made of a shredded non-crushable low density polyurethane foam.
